(19) United States
(12) Patent Application Publication
(10) Pub. No.: US 2004/0246707 A1
(43) Pub. Date: Dec. 9, 2004

(54) Hand tool

(75) Inventors: Koichi Miyamoto, Saitama (JP); Koichi Maruyama, Osaka (JP)

Correspondence Address: SUGHRUE MION, PLLC, 2100 Pennsylvania Avenue N.W., Washington, DC, 20037-3213, US

(73) Assignee: SUNCREO CORPORATION

(21) Appl. No.: 10/816,940

(22) Filed: Apr. 5, 2004

(30) Foreign Application Priority Data
Jun. 3, 2003 (JP) 2003-158246

(51) Int. Cl. B25B 23/18

(52) U.S. Cl. 362/119

(57) ABSTRACT

A hand tool with an easy-to-grip holder portion allows a large amount of torque to be applied to the tool, so that the tool can be rotated stably and screws or the like can be easily and reliably fastened. A hand tool 1 includes a holder portion 2 from which a plurality of tools 10 can be selectively swung out for use. The holder portion 2 comprises two holder plates 3 and 4 disposed opposite to each other and spaced from each other, and three connecting axles 20 to 22 by which the two holder plates are connected. The two holder plates each include three protruding plate portions 6 extending from a plate center portion 5 in three directions. The three connecting axles are individually fixed to the three protruding plate portions. The plurality of tools are supported by the three connecting axles individually and swingably. The tools are capable of being accommodated within a distance S. The connecting axle 20 is fixed at a position displaced from a center line CL1 of the protruding plate portion 6 by a distance x1. The holder portion 2 is disposed in parallel to stopper axles 25 and 26 at a position spaced from the center line CL1 towards the opposite side by a distance y1, the stopper axles limiting the range of swing of the tools.

### BACKGROUND OF THE INVENTION

1. Field of the Invention

The present invention relates to a hand tool capable of selectively providing a plurality of tools, such as a Phillips-head screwdriver, a flathead screwdriver and a hexagonal wrench. Particularly, the invention relates to a hand tool equipped with an easy-to-grip holder portion, capable of turning and fastening a screw, a hexagonal bolt or the like easily and reliably.

2. Background Art

FIG. 5 shows an example of the aforementioned type of hand tool 50 capable of selectively providing a plurality of tools. The illustrated hand tool includes two support axles 52 at either end of a holder portion 51 in the main body, on which multiple tools are mounted in a freely swinging fashion. The tools, which protrude from the holder portion in the main body when in use, include a. Phillips-head screwdriver 53, a flathead screwdriver 54 and hexagonal wrenches 55 and 56, for turning and driving a Phillips screw, a flathead screw and a hexagonal socket head bolt, respectively. (See WO97/29887, for example)

### SUMMAR OF THE INVENTION

In the previously described hand tool, a tool 56 to be used is selected from a plurality of tools and taken out of the holder portion 51 in the main body by swinging about the support axle 52, as shown in FIG. 5b. The thus extended tool has a center line L2 that is displaced from a centerline L1 of the holder portion, as shown in FIG. 5b. Thus, when the hexagonal wrench or screwdriver, for example, is rotated, the holder portion must be rotated eccentrically with respect to the center line L2 of the tool, due to the displacement. This makes it more difficult to rotate the tool and to apply a large amount of rotation torque on the bolt or screw, resulting in an unreliable fastening.

Further, the extended tool 56 can be swung in either direction about the support axle 52, as indicated by two-dot chain lines. Thus, the tip of the tool is unstable, which makes it similarly more difficult to apply a large amount of rotation torque on the tool. The holder portion has a small width W relative to the tool the tip of which is rotated. This results in a small radius of rotation of the holder 51 about the tool center line L1, preventing the application of a large amount of torque on the tool. In addition, as the length of the tool and that of the holder portion lie in the same direction, it is difficult to hold the holder portion and to rotate the tool.

The present invention has been achieved in view of these problems of the prior art and has as its objective the provision of a hand tool with an easy-to-grip holder portion which is capable of applying a large amount of torque at the tip of the tool while preventing the fluctuation of the tool tip. Another object of the invention is to provide a hand tool capable of reliably fastening a screw or bolt with the application of a large amount of torque and capable of being used in a dark environment.

In order to achieve the aforementioned objects, the invention provides a hand tool comprising a holder portion from which a plurality of tools can be selectively swung out for use. The holder portion comprises two holder plates disposed opposite to each other with a distance provided therebetween, and three connecting axles connecting the two holder plates. The two holder plates each include three protruding plate portions extending from a plate center portion in three directions. The three connecting axles are individually fixed to said three protruding plate portions, and the plurality of tools are supported by said three connecting axles individually in a freely swinging manner and are adapted to be accommodated within said distance.

In the thus constructed hand tool according to the invention, as the holder portion includes the three protruding plate portions, the protruding plate portions supporting the tool that has been selected and swung out can be held between the middle and ring fingers. As a result, the holder portion in the main body can be easily gripped. Further, as the tip of the tool that has been swung out is protruding outwards from the protruding plate portion in the holder portion, the holder portion can be easily rotated. The holder portion has a wide width so that a large amount of torque can be applied to a bolt or screw, allowing the bolt or screw to be reliably fastened.

In a preferred embodiment of the invention, the three connecting axles are each fixed at positions displaced from a center line of the protruding plate portion. Specifically, the base-end of the tool is bent in one direction such that the tool is formed in a “b” shape. As a result, the center line of the tool tip can be substantially aligned with the center line of the holder portion even when the tool tip and the center of swing are out of alignment. Thus, the holder portion can be easily rotated about the tool center line, thus facilitating and making more efficient the fastening operation or the like.

In yet another embodiment of the invention, the holder portion comprises a stopper axle parallel to each connecting axle, by which stopper axle the range of swing of said plurality of tools is limited. The stopper axle is fixed between said two holder plates such that, as any of said plurality of tools is abutted against said stopper axle, a center line of the tool that has been swung is substantially aligned with the center line of said protruding plate portion. The external diameter of the stopper axle is preferably varied in accordance with the thickness of the tool. In this embodiment, the tool is swung about the connecting axle and abuts against the stopper axle, whereupon the center line of the tool is substantially aligned with that of the holder portion. As a further rotation of the tool is thus prevented, the tip of the tool is stable and the center of rotation of the tool that has been selected and swung open does not move. Thus, the operation of the tool is facilitated and a large amount of torque can be applied to the screw or the like.

The holder portion preferably comprises an illuminating device for illuminating the tip of the tool that has been selected and swung, said illuminating device being capable of being pulled from and pushed back into said holder portion. In this configuration, the illuminating device can be extended out of the center portion of the holder portion and illuminate the tip of the tool, the fastening of a screw or bolt, for example, in a dark environment can be easily performed. Preferably, the illuminating device is disposed at the center of said holder portion and is supported rotatably in said holder portion, such that it can illuminate the tip of the tool that has been selected and swung open. In the thus configured hand tool, the single illuminating portion can be rotated to illuminate in the direction of the tool that has been selected and swung open, thus facilitating the operation in a dark environment.

### BRIEF DESCRIPTION OF THE DRAWINGS

FIG. 1 shows an embodiment of the invention, with (a) showing a front view and (b) showing a right-side view.

FIG. 2(a) shows a plan view of FIG. 1 and FIG. 2(b) shows a bottom view of FIG. 1.

FIG. 3(a) shows a cross-section of a principal portion of an illuminating device taken along line A-A of FIG. 1(a), and FIG. 3(b) shows a cross-section of the principal portion when the light is turned on.

FIG. 4(a) shows a cross-section of a principal portion taken along line B-B of FIG. 3, and FIG. 4(b) shows a cross-section of the principal portion when rotated.

FIG. 5 shows a hand tool equipped with a plurality of tools according to the prior art, with (a) showing its general structure and (b) showing it when in use.

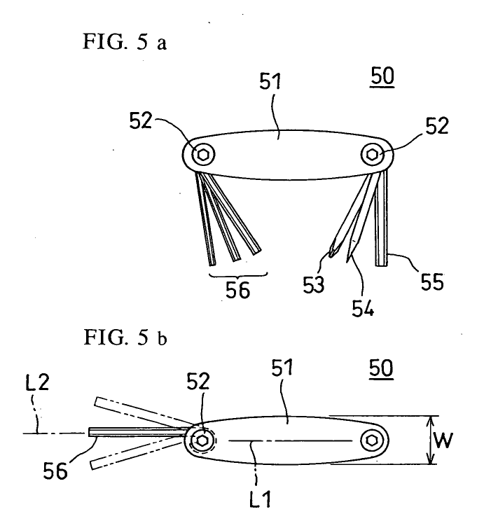

### DESCRIPTION OF THE PREFERRED EMBODIMENTS

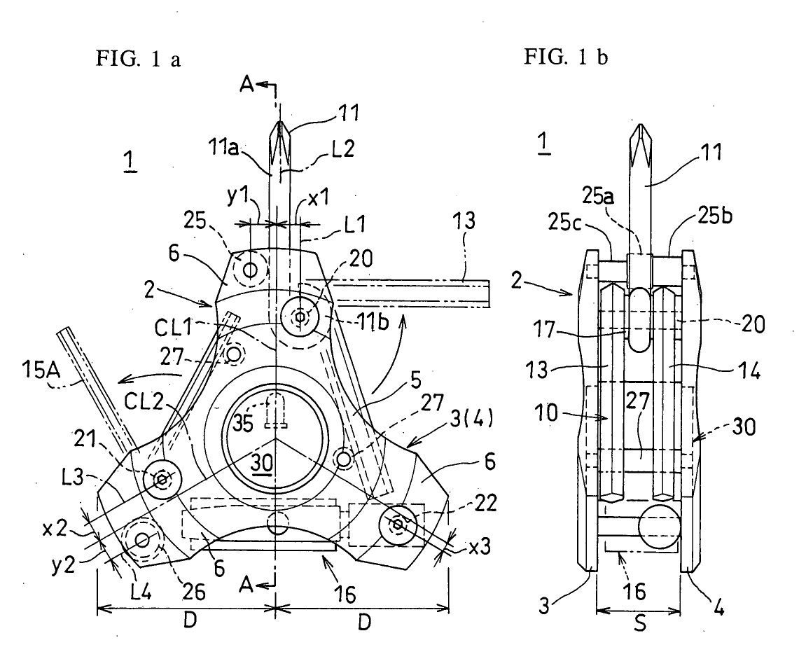

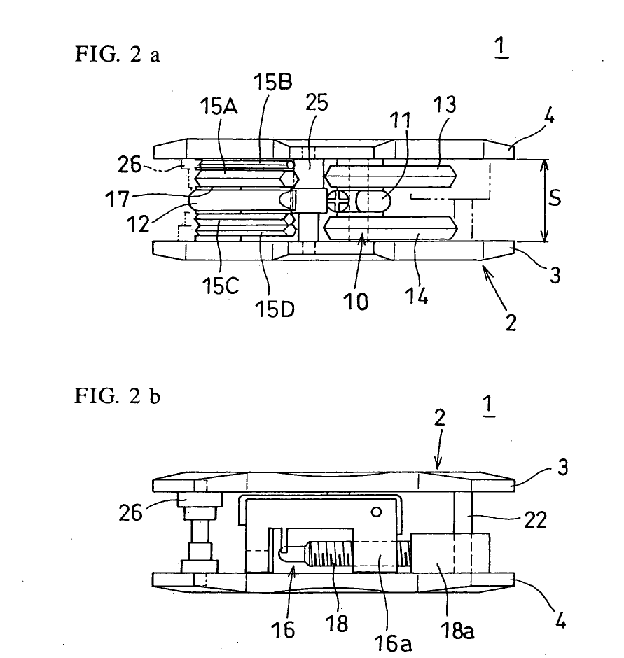

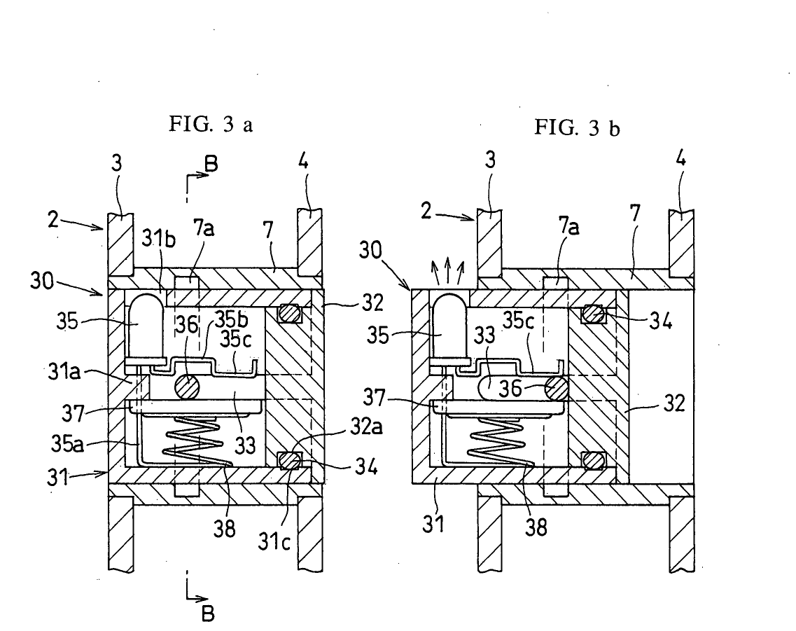

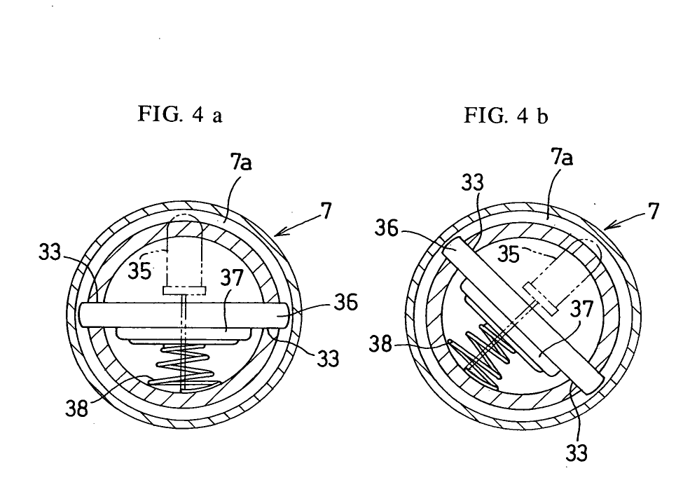

An embodiment of a hand tool according to the invention will be hereafter described with reference made to the drawings. FIG. 1 shows a front view and a right-hand side view of the hand tool of the embodiment. FIG. 2 shows a plan view and a bottom view of the hand tool of FIG. 1. FIG. 3 shows a cross-section of a principal portion of an illuminating device taken along line A-A of FIG. 1, when the device is turned off and on. FIG. 4 shows a cross-section taken along line B-B of FIG. 3, and a similar cross-section when the illuminating device is turned. In these drawings, some parts in the back of the tool are omitted for ease of understanding.

Referring to FIGS. 1 and 2, a hand tool 1 comprises a holder portion 2 in which a plurality of tools 10, such as a Phillips-head screwdriver, a flathead screwdriver and a hexagonal wrench, are accommodated. The hand tool 1 is adapted such that one of the tools can be selected and extended from the holder portion 2 in a swinging fashion and then used. In the present embodiment, the plural tools 10 include a Phillips-head screwdriver 11, a flathead screwdriver 12, six hexagonal wrenches 13 to 15 with different thicknesses, and a chain cutter 16.

The holder portion 2 comprises two holder plates 3 and 4, and three connecting axles 20, 21 and 22 for supporting the holder plates 3 and 4 with a distance S. The distance S provides the space for accommodating the multiple tools 10. The holder plates 3 and 4 are made of metal plates such as aluminum plates or synthetic resin plates, and they are basically formed in the shape of a triangle when seen a plan view. They may, therefore, have shapes such as a triangle with its three vertexes rounded, a rough Y shape where three bars are extending from the center in three directions, or a triangle with its three vertexes chamfered with a line or a curve, for example. The holder plates in the embodiment are basically formed in a Y shape, more or less, where protruding plate portions 6 extend from a plate center portion 5 in three directions at regular intervals of 120°. They are symmetric in terms of shape to each other.

The two holder plates 3 and 4 are securely connected to each other by the three connecting axles 20, 21 and 22, with the distance S provided therebetween. In either end of the connecting axles are formed screw holes (not shown), in which hexagonal socket head bolts are threaded to securely fasten the holder plates 3 and 4. The connecting axles and the holder plates may be fixed by means other than the aforementioned screw fastening, such as by press-insertion or swaging, as appropriate. The plural tools 10 including the Phillips-head screwdriver, flathead screwdriver, and hexagonal wrenches are inserted between the distance S and are supported by the connecting axles 20, 21, and 22 in a freely swinging fashion.

The two holder plates 3 and 4 have opposed inner surfaces that are flat, and their outer surfaces are formed such that they have a thin and flat central portion that inclines with gradually increasing thickness and connects to a thick and flat surface, which then inclines with gradually decreasing thickness. The individual surfaces on the outer surface are formed in circles, as shown in FIG. 1a. Thus, the projections on the periphery of the holder portion 2 are chamfered, so that, together with the thin central portion, the holder portion 2 can be easily gripped. An arch-shaped concave portion is formed at a central portion of each peripheral side of the holder plates 3 and 4, from which the accommodated tools are exposed. The concave portion allows the tools inside to be easily reached by a finger and swung.

In the present embodiment, the Phillips-head screwdriver 11 is supported on the connecting axle 20 in the middle, and a large-diameter hexagonal wrench 13 and an intermediate-diameter hexagonal wrench 14 are positioned at either side of the screwdriver. On the connecting axle 21 are supported four small-diameter hexagonal wrenches 15A to 15D with different sizes, and the flathead screwdriver 12 is located in the middle. On the connecting axle 22 is supported another tool, namely the chain cutter 16 for cutting the chain of a bicycle, for example. When a plurality of tools are supported on a single connecting axle, a spacer ring 17 is interposed so as to help the swinging movement of the individual tools 10. Each tool is fit on the connecting axle without gap such that they can all swing against frictional force.

The tools 10 each have a ring portion formed by bending them in one direction at their base portions with respect to their tip portions, such that they have an asymmetric shape like that of the letter “b” when seen in a plan view. For example, the Phillips-head screwdriver 11 has a ring portion 11b at its base as well as a tip portion 11a, as shown in FIG. 1a. The ring portion 11b has an internal diameter greater than the external diameter of the connecting axle 20 such that the Phillips-head screwdriver 11 can be swung about the connecting axle 20. A center line L1 of the ring portion 1b is displaced from a center line L2 of the tip portion 11a of the tool. In order to substantially align the center line L2 of the tool with a center line CL1 of the holder portion 2, the connecting axle 20 supporting the tool is displaced to one side from the center line CL1 of the holder portion 2.

Thus, the center of the connecting axle 20 is displaced from the center line CL1 of one of the protruding plate portions 6 of the holder plate 3 by a distance x1, and the multiple tools 10 are adapted to be swung by an angle of approximately 150° about the connecting axle. The distance x1 between the center line L1 of the connecting axle 20 and the center line CL1 of the holder portion 2 is determined in accordance with the external diameter of the tool supported on the connecting axle. Specifically, the distance x1 is set to be large because the external diameter of the tool supported on the connecting axle 20 is large, while the distance x2 is set to be small because the external diameter of the tool supported on the connecting axle 21 is small. Thus, the displacement distances x1 and x2 are set in proportion to the external diameter of the tool that is supported, so that each tool can be aligned with the center line of the holder portion 2 when swung to an open position.

Two stopper axles 25 and 26 are fixed between the holder plates 3 and 4 in parallel with the three connecting axles 20 to 22. The stopper axle 25 is displaced from the center line CL1 of the protruding plate portion 6 in the direction opposite to that of the connecting axle 20 by a distance y1. The stopper axle 25 is also positioned more towards the periphery than the connecting axle 20, and is a stepped axle with various diameters adapted for different tools. Similarly, the stopper axle 26 is displaced from the center line CL2 of another protruding plate portion 6 towards the direction opposite to that of the connecting axle 21 by a distance y2. Also, the stopper axle 26 is positioned more towards the periphery than the connecting axle 21, and it is a stepped axle with various diameters adapted for different tools.

For example, the external diameter of a central portion 25a of the stopper axle 25 on which the Phillips-head screwdriver abuts is set such that the screwdriver is substantially aligned with the center line CL1 of the holder portion 2 when the driver is swung and abutted on the central portion 25a. The external diameter of a right-side portion 25b of the stopper axle in FIG. 1b onto which the hexagonal wrench 14 with a larger diameter abuts is smaller than that of the central portion 25a. Further, the external diameter of a left-side portion 25c in FIG. 1b on which the hexagonal wrench 13 with an even larger diameter abuts is even smaller than that of the right-side portion 25b. Thus, the tools with different thicknesses are adapted to abut on different positions of the stopper axle when swung open, so that each tool can be substantially aligned with the center line CL1 of the holder portion 2.

On the connecting axle 21 are supported tools smaller than the tools supported on the connecting axle 20, and the distance x2 of displacement between the center line CL2 of the protruding plate portion 6 of the holder portion 2 and a center line L3 of the connecting axle 21 is set to be smaller than the distance x1 for the connecting axle 20. For the stopper axle 26 positioned on the opposite side of the center line CL2 from the connecting axle 21, the displacement distance y2 between a center line L4 of the stopper axle 26 and the center line CL2 of the holder portion 2 is set to be smaller than that for the connecting axle 20. The stopper axle 26 also has various external diameters for different tools that abut on it. Specifically, the external diameter of a central portion on which the flathead screwdriver 12 with a large external diameter abuts is small, and other portions of the stopper axle 26 are provided with different external diameters for hexagonal wrenches 15A to 15D with different external diameters. Thus, the stopper axle 26 is also a stepped axle.

Preferably, either stopper axels 25, 26 or the tools that come into contact with the stopper axles, such as Phillips-head screwdriver 11, may be magnetized, and the other may be formed of a magnetic material. For example, stopper axel 25 may be magnetized and the tools supported by the connecting axles 20, such as Phillips-head screwdriver 11, 13 and hexagonal wrenches 13, 14, may be formed of a ferromagnetic material, such as iron. By so doing, the tool that is selectively swung out can be drawn to stopper axle 25 as it abuts stopper axle 25. Consequently, the tip portion of the tool that is projected from the holder can be stabilized.

Between the holder plates 3 and 4 of the holder portion 2 are further supported two accommodation stopper axles 27, on which the plural tools 10 abut when accommodated. The accommodation stopper axles 27, however, are not necessarily needed. For the chain cutter 16, no stopper axle is provided because the cutter does not need to be positioned when in use. However, a similar stopper axle may be provided on which the chain cutter 16 can abut when it is swung open.

The chain cutter 16 includes a main body portion 16a formed in the shape of a bracket (“]”) and a push-in axle 18 threaded through one leg-portion of the main body portion. It is possible to cut a chain using the chain cutter 16 by placing the chain (not shown) between the other leg-portion of the main body portion 16a and the push-in axle, and by turning the push-in axle to thereby push out the pin in the chain. The chain cutter 16 is supported in the holder portion 2 as another tool such that a base portion 18a of the push-in axle is supported on the connecting axle 22 in a swinging fashion. The connecting axle 22 is displaced from the center line of the protruding plate portion by a distance x3. A swing hole for the insertion of the connecting axle 22 is formed at the center of the base portion 18a of the chain cutter 16, so that there is no need to displace the connecting axle.

Referring next to FIGS. 3 and 4, an illuminating device 30 located at the center of the holder portion 2 will be described. The illuminating device 30 is basically columnar in shape and is capable of emerging from and sinking back into the holder portion 2. The illuminating device 30 is also rotatably supported. A cylindrical portion 7 is fixed in the plate center portion 5 of the holder portion 2, thus forming a cylindrical through hole, in which the illuminating device 30 is fitted such that it can be moved out of the plane of one holder plate 3 in a perpendicular direction, namely in the axial direction of the column. Along the entire circumference of the cylindrical portion 7 on the inside is formed a locking groove portion 7a. The illuminating device 30 includes a columnar illuminating case 31 with one end that is open and the other that is closed, and a cover 32 with which the opening of the illuminating case is closed.

The illuminating case 31 has a projection 31a at the bottom center and an illuminating hole 31b in the side wall. Two sliding grooves 33 are formed opposite each other on the external circumferential wall portion of the case, extending from the opening along the axis. On the inside of the casing more towards the opening is formed a circumferential shallow groove 31c. A rubber ring 34 is fitted between the shallow groove 31c and a circumferential groove 32a formed along the circumference of the cover 32, such that the illuminating case 31 and the cover 32 can be secured to each other. By removing the cover 32, a battery inside, which will be described later, can be exchanged. An LED 35, which is a light-emitting element, is inserted into the illuminating hole 31b on the periphery and fixed therein. Thus, the direction of the light-emitting element can be changed by rotating the illuminating case 31.

In the locking groove 7a along the internal circumference of the cylindrical portion 7 is engaged the ends of a metal rotary support axle 36, which is inserted into the sliding grooves 33 of the illuminating case 31. Thus, the illuminating case 31 can be moved axially within a range in which the rotary support axle 36 can travel in the sliding grooves 33. The illuminating case 31 can be freely rotated within the cylindrical portion 7 as the ends of the rotary support axle 36 are rotated in the locking groove portion 7a.

A battery 37 is inserted in the illuminating case 31. One terminal of the battery abuts the projection 31a and the rotary support axle 36. Against the other terminal of the battery abuts a pressure spring 38, with which the one terminal of the battery is pressed against the rotary support axle 36. A base portion of the pressure spring 38 is connected to one terminal 35a of the LED 35. The other terminal of the LED 35 is bent to form a non-conducting portion 35b which is not adapted to come into contact with the rotary support axle 36 and a conducting portion 35c which is adapted to come into contact.

While the LED 35 is adapted such that a dc voltage from the battery 37 is directly applied thereto, a pulsed-lighting circuit or the like may be employed for intermittent lighting. In this configuration, the lifetime of the battery can be extended. Further, while the cover 32 is fixed relative to the illuminating case 31 with the rubber ring 34, the cover may be adapted to be threaded into the case.

Hereafter, the operation of the hand tool 1 as constructed above according to the present embodiment will be described. When a Phillips-head screw (not shown) is fastened using the hand tool 1, the Phillips-head screwdriver 11 is swung out of the internal space of the holder portion 2. As the Phillips-head screwdriver 11 is swung by about 150°, it abuts the central portion 25a of the stopper axle 25 and is thus positioned, so that its tip is stable. At the same time, the center line L2 of the tip portion of the Phillips-head screwdriver 11 is substantially aligned with the center line CL1 of the holder portion 2, so that they are directed in the same direction.

When operating the hand tool 1 in which the Phillips-head screwdriver is thus set, the tool tip portion 11a is inserted into the cross-shaped recess on the head of the Phillips-head screw and then the holder portion 2 is rotated. Because the holder portion 2 is easy to hold with hand and the center line L2 of the tool tip portion 11a is substantially aligned with the center line CL1 of the holder portion 2, the holder portion 2 can be easily rotated. Further, as the holder portion 2 comprises the protruding plate portions 6 protruding in three directions, a large distance D is provided from the center line CL1 (see FIG. 1), so that a large amount of torque can be applied to the Phillips-head screw. In addition, the swinging of the tool tip portion 11a is limited by the stopper axle 25, so that a large amount of torque can be reliably applied to the screw head, thus ensuring a reliable fastening of the screw.

When the hand tool 1 is used as the flat-head screwdriver 12, the Phillips-head screwdriver 11 is swung in the opposite direction and accommodated back in the holder portion 2, and instead the flathead screwdriver 12 is swung out of the holder portion 2. The flat-head screwdriver 12 is swung about the connecting axle 21 and abuts the stopper axle 26 where it is positioned. In this case, too, the center line of the tool tip portion of the flat-head screwdriver 12 is substantially aligned with the center line CL2 of the protruding plate portion of the holder portion 2, so that the holder portion 2 can be easily rotated about the flat-head screwdriver 12. The swinging of the flat-head screwdriver 12 is stopped by the stopper axle 26 where large distance D can be obtained from the center line of the holder portion 2, so that a large amount of torque can be applied to the flat-head screw (not shown).

Similarly, the hexagonal wrenches with different thicknesses can be selected and swung out in order to fasten hexagonal socket head bolts with different screw diameters. The thick hexagonal wrench 13 and the thin hexagonal wrench 14 have different planes of abutment against the stopper axle 25. Specifically, as shown in FIG. 1b, the thick hexagonal wrench 13 abuts the small-diameter left-hand portion 25c of the stopper axle, while the thin hexagonal wrench 14 abuts the large-diameter right-hand portion 25b of the stopper axle, so that the tool tips of the tools can be directed substantially in the same direction as the center line CL1 of the holder portion 2. Thus, the center line of the tools can be substantially aligned with the center line of the holder portion, thus facilitating the rotation of the tools.

When the chain cutter 16 is used, the chain cutter 16 is swung about the connecting axle 22 out of the holder portion 2. The main body portion 16a is then unfastened from the push-in axle 18 to provide a space between the legs. The chain (not shown) is then placed in this space, and the tip of the push-in axle 18 is abutted against the pin of the chain. As the push-in axle 18 is pushed in by rotating the holder portion 2, the pin can be displaced in the axial direction, thus cutting the chain. Thus, the hand tool 1 of the embodiment can reliably cut a chain as well as fastening Phillips-head screws, flat-head screws and various hexagonal socket head bolts. The hand tool 1 is therefore suitable for bicycles.

When performing the fastening operation or the like in a dark environment, the operation can be facilitated by activating the illuminating device 30. The columnar illuminating case 31 at the center of the holder portion 2 can be slid axially and caused to emerge out of the holder plate 3. As a result, the LED 35 located on the column surface is exposed and can be then lighted. Specifically, as the illuminating case 31 is pushed to the left in FIG. 3a and thus extended out of the holder portion 2, the sliding groove portion 33 is moved relative to the rotary support axle 36, until the rotary support axle 36 comes into contact with the cover 32, as shown in FIG. 3b, whereupon the illuminating case 31 comes to a stop. In this state, the conducting portion 35c of the LED 35 is in contact with the rotary support axle 36 and is therefore in contact with one terminal of the battery via the metal rotary support axle 36. The LED 35 is therefore turned on and the light illuminates the tip of the tool that is extended. The illuminating case 31 can be rotated by 360° along its circumference, so that the LED 35 can be freely oriented in the direction of the tool used in order to illuminate the tip of the tool.

After the operation such as the fastening operation is completed, the tool such as the Phillips-head screwdriver 11 is swung back into the holder portion 2 between the distance S, which is the storage space. If the illuminating device 30 had been used, the illuminating case 31 is pushed into the holder portion 2. As a result, the conducting portion 35c of the LED 35 is moved relative to the rotary support axle 36 and instead the non-conducting portion 35b is brought opposite the rotary support axle 36, so that the LED 35 is turned off. At this point, the hand tool 1 does not have anything protruding therefrom and assumes a shape such that it can be easily stored or transported.

While a preferred embodiment of the invention has been described using specific terms, such description is for illustrative purposes only, and it is to be understood that changes and variations may be made without departing from the spirit or scope of the following claims. For example, the tools are not limited to Phillips-head screwdrivers, flat-head screwdrivers or hexagonal wrenches as described above, but they may be screwdrivers or spanners with specific tip shapes. The hand tool may also support screwdrivers with different diameters, tools for turning nuts, or screw-cutting taps, in a swinging fashion.

The illuminating device may include three illuminating portions adapted to be selectively turned on in accordance with the tools supported by the three connecting axles. While the illuminating device has been described to be automatically turned on when extended from the holder portion, the illuminating device may be adapted to be turned on by a separate switch. Further, the mechanism for moving and rotating the illuminating device is not limited to the example described above but may be configured in other manners.

As will be understood from the above description, the hand tool of the invention can apply a large amount of rotation torque to a screw or the like via the easy-to-grip holder portion. As the tool tip is substantially aligned with the center of the holder portion, the tool can be easily rotated, resulting in a reliable fastening operation for screws or the like. The tool tip portion can be illuminated by the illuminating device, so that the fastening operation or the like in a dark location can be easily performed.

1. A hand tool comprising a holder portion from which a plurality of tools can be selectively swung out for use, said holder portion comprising two holder plates disposed opposite to each other with a distance provided therebetween, and three connecting axles connecting said two holder plates, wherein said two holder plates each include three protruding plate portions extending from a plate center portion in three directions, wherein said three connecting axles are individually fixed to said three protruding plate portions, and wherein said plurality of tools are supported by said three connecting axles individually in a freely swinging manner and are adapted to be accommodated within said distance.

2. The hand tool according to claim 1, wherein said three connecting axles are each fixed at positions displaced from a center line of each protruding plate portion.

3. The hand tool according to claim 1, wherein said holder portion comprises a stopper axle parallel to said connecting axles, by which stopper axle the range of swing of said plurality of tools is limited, wherein said stopper axle is fixed between said two holder plates such that, as any of said plurality of tools is swung out and abutted against said stopper axle, a center line of the tool that has been swung is substantially aligned with the center line of said protruding plate portion.

4. The hand tool according to claim 1, wherein said holder portion comprises an illuminating device for illuminating the tip of the tool that has been selected and swung, said illuminating device being adapted to be pulled from and pushed back into said holder portion.

5. The hand tool according to claim 4, wherein said illuminating device is disposed at the center of said holder portion and is supported rotatably in said holder portion, such that it can illuminate the tip of the tool that has been selected and swung open.
